(19) United States
(12) Patent Application Publication
(10) Pub. No.: US 2006/0112357 A1
(43) Pub. Date: May 25, 2006

(54) Sensitivity-current-based model for equivalent waveform propagation in the presence of noise for static timing analysis

(76) Inventors: Shahin Nazarian, South Pasadena, CA (US); Tao Lin, Sunnyvale, CA (US); Emre Tuncer, Santa Cruz, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/264,919

(22) Filed: Nov. 1, 2005

Related U.S. Application Data
(60) Provisional application No. 60/624,352, filed on Nov. 1, 2004.

(51) Int. Cl. G06F 17/50; G06F 9/45

(52) U.S. Cl. 716/4; 716/5

(57) ABSTRACT

A system and a method are disclosed for modeling an electronic element. Sensitivity of an output current to an input voltage without noise is determined. Output current is calculated in the event noise is present at an input using sensitivity. An output voltage is derived from the output current. The output current waveform may be derived using a Taylor expansion.

### CROSS REFERENCE TO RELATED APPLICATIONS

This application claims the benefit and priority under 35 USC § 119(e) to U.S. Provisional Patent Application No. 60/624,352 titled “Sensitivity-Current-Based Approach for Equivalent Waveform Propagation in the Presence of Noise for the Purpose of Static Timing Analysis”, the contents of which are herein incorporated by reference.

### BACKGROUND OF THE INVENTION

1. Field of the Invention

The present invention generally relates to the field of electronic design automation, and more specifically, to electronic design automation using static timing analysis for circuits having noise.

2. Description of the Related Art

Electronic design automation (EDA) is used extensively in the design of integrated circuits. An electronic circuit under design is evaluated using models of devices and interconnections between the devices. A simulation using these models is then run to test the performance of the circuit.

Static timing analysis is a methodology of electronic design automation for verifying whether the circuit under design meets desired timing criteria. The drastic scaling down rate of layout geometries, as well as the increase in operating frequency increases noise effects of different types. Some common types in nanotechnologies are the capacitive coupling, resistive shielding, inductive interconnects, and voltage supply spikes. Any distortion of a voltage waveform at the input of a gate during operation of the circuit, from the waveform used during characterization of that gate may be considered as a noise effect. Present static timing analysis tools (STAs) may not properly calculate and propagate timing information and check the timing criteria in the presence of noise.

From the above, there is a need for a system and process to provide an EDA model for more accurate calculations and propagation analysis of noisy waveforms through gates and interconnects.

### SUMMARY OF THE INVENTION

The present invention includes a system and a method for modeling an electronic element. Sensitivity of an output current to an input voltage without noise is determined. Output current is calculated in the event noise is present at an input using sensitivity. An output voltage is derived from the output current.

In one aspect, a derivative of output current over input voltage is characterized for a noiseless input. A derivative of output current over input voltage is characterized for a noisy waveform. An output current waveform is derived using a Taylor expansion. The output current is integrated using an equivalent load capacitance.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 illustrates an electronic design automation system.

FIGS. 2A and 2B are timing diagrams illustrating input and output voltage waveforms, respectively, of an inverter with noisy input.

FIG. 2C is a schematic diagram illustrating the inverter corresponding to the waveforms of FIGS. 2A and 2B.

FIG. 3A is a timing diagram illustrating an equivalent linear input waveform of the waveform of FIG. 2A.

FIG. 3B is a timing diagram illustrating an output waveform resulting from the equivalent linear input waveform of FIG. 3A.

FIG. 4 is a flow chart illustrating a process to determine an output current model using sensitivity analysis according to the present invention.

FIG. 5 is a flow chart illustrating a process to determine an output current model using a Taylor expansion for the process of FIG. 4.

FIG. 6 is a timing diagram illustrating output current for an input current for an inverter.

FIG. 7 is a timing diagram illustrating a derivative of output current to input voltage for a noiseless waveform of FIG. 6.

FIG. 8 is a timing diagram illustrating a derivative of output current to input voltage for a noise input as derived from the derivative of the noiseless waveform of FIG. 7.

FIG. 9 is a timing diagram illustrating an equivalent output current for the noisy input voltage of FIG. 8.

FIG. 10 is a timing diagram illustrating an equivalent output voltage for the noisy input voltage of FIG. 8.

FIG. 11 is a timing diagram illustrating output current and voltage waveforms for real case and model determined according to the present invention.

### DETAILED DESCRIPTION OF THE PREFERRED EMBODIMENTS

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The present invention includes a system and method for determining propagation and timing information of gates. The system and method of the present provide output current that behaves as a function of the input voltage with noise induced distortions, using available characterized cell library models (e.g., ECSM (Effective Current Source Model)), whereas all current approaches try to approximate the output voltage timing information as a function of input. An advantage of this approach is that it conveys the shape of the output voltage rather than only reporting the delay and slew that is seen in conventional approaches. The present invention may reduce the pessimism or optimism of common approaches in industry and/or literature.

The systems and methods of the present invention may directly generate the equivalent output without attempting to generate an equivalent linear input. The STA may use an equivalent input, an equivalent output and a backward approach from the output to input. Thus, having the equivalent output, a measure of the output slew and an arrival time, and using the library, an equivalent slew and arrival time that generates the parameters at the output may be determined.

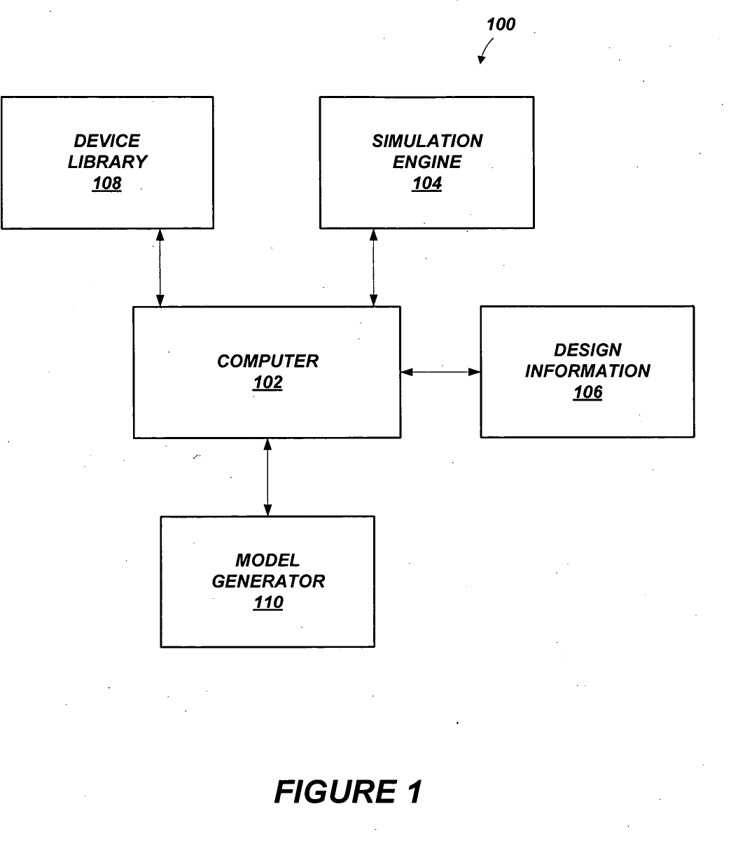

FIG. 1 is a block diagram illustrating an electronic design automation system 100. A computer 102 executes a simulation engine 104 for simulating the operation and performance of an electrical circuit under design. The computer 102 receives design information 106, such as a net list, corresponding to the electrical circuit under design. The computer 102 retrieves corresponding models from the device library 108, and executes a design simulation using the simulation engine 104. The electronic design automation system 100 further comprises a model generator 110 for generating device models for circuits that are stored in the device library 108. The simulation engine 104, the design information 106, the device library 108, and the model generator 110 may reside in a memory internal or external to the computer 102.

The model generator 10 generates a model indicative of equivalent output waveform characteristics of a circuit element in response to a noiseless input or a noisy input. In one embodiment, the model is linear. The model generator 10 determines the slew of the output in response to the slew of the linear input waveform and the output capacitance. The present invention, however, is not limited to a linear waveform expression and may be applied to other waveform expressions, such as ramp or exponential.

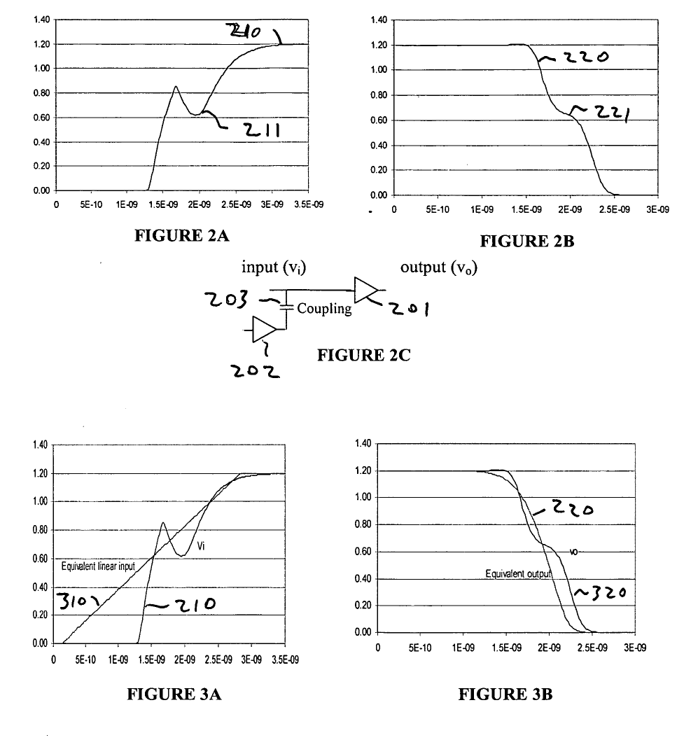

FIGS. 2A and 2B are timing diagrams illustrating input and output voltage waveforms, respectively, of an inverter with noisy input. FIG. 2C is a schematic diagram illustrating the inverter corresponding to the waveforms of FIGS. 2A and 2B. In the illustrative embodiment of FIG. 2C, an inverter 201 receives an input voltage vᵢ that includes noise received from another signal path, e.g., an output of another inverter 202 that is capacitively coupled to the input of the inverter 201 through a parasitic capacitance shown schematically in FIG. 2C as a capacitor 203. The input voltage vᵢ is shown as a line 210 with a voltage drop 211 that is caused by the coupling of the switching of the inverter 202. In response to the input waveform vᵢ, the inverter 201 generates an output voltage vₒ. The output voltage waveform of the output voltage vₒ is represented by a line 220 that has a voltage shift 221 corresponding to the voltage drop 211 (FIG. 2A).

FIG. 3A is a timing diagram illustrating an equivalent linear input waveform of the waveform of FIG. 2A. FIG. 3B is a timing diagram illustrating an output waveform resulting from the equivalent linear input waveform in FIG. 3A. The model generator 110 generates an equivalent waveform for a noisy input waveform. As an illustrative embodiment, a linear waveform is described. In another embodiment, the waveform may be expressed by other waveform expressions, such as ramp or exponential. The model generator 110 generates an equivalent linear input shown as line 310 (FIG. 3A) as an equivalent to the input in such form 210 (FIG. 2A) and generates an output shown as line 320 (FIG. 3B) responsive to the equivalent linear input 310 as an equivalent to the output waveform 220 (FIG. 2B). The model generator 110 generates a linear waveform (line 320) based on a linear input waveform (line 310) and an output capacitance to generate a slew of the output.

The model generator 110 may generate the linear waveform using processes falling into four classes, namely Point-Based; Least Square Fitting-Based; Energy-Based; and Sensitivity-Based.

Using a Point-Based Approach, the model generator 110 determines a line passing through the point where the noisy input passes a voltage level that is one-half (50% point) of the supply voltage V_{dd} level, (e.g., a typical value of 1.2 volts in a 130 nanometer process technology). This slope may be selected as the slope of either the noiseless or noisy input.

Using a Least Square Fitting-Based Approach, the model generator 110 minimizes the square of differences between an equivalent input line and the noisy input to generate the equivalent input line. The difference are minimized over a time range [t₁, t₂], where times t₁ and t₂ may be selected as the time points where the noisy input passes 10% and 90% of the supply voltage Vdd, respectively.

In another embodiment of the least squared fitting-based approach, the model generator 110 uses a weight which is defined as the derivative of output voltage to input voltage for the noiseless input. The time range for this weighting may be defined over a limited range, say [t′₁, t′₂]; the time t′₁ is defined as the time the noiseless input pass 10% of the supply voltage Vdd. The time t′₂ is defined as the earliest time that input or output voltage signal passes 90% of Vdd. Because the weighted square fitting is accomplished for a limited bound, the noise that affects the input waveform outside this bound is ignored. In many instances, this is not as efficient as desired. Specifically, the more the number of aggressors are, the more the possibility exists for this approach to highly over or under-estimate the timing information at the output of the gate. Enhancing the weighted square fitting methodology to consider the noise regardless of where it occurs may provide results that are more accurate than the one with the limited range.

Using an Energy-Based approach, the model generator 110 determines an equivalent input line passing from the point where the input signal passes 50% of the supply voltage Vdd for the last time and selects the slope such that the area surrounded by that line, and the straight lines v₁(t)=0.5×Vdd and v₂(t)=Vdd is equalized with that of the noisy input and the lines v₁ and v₂.

This approach is usually highly pessimistic, because it always uses the last point where the noisy input passes 50% of the supply voltage Vdd, whereas in many cases the output makes its transition before this point. This approach underestimates the output delay. For example, if the noisy input makes fluctuations around above 0.5×Vdd the result can be optimistic. The greater the number of crosstalk aggressors, the greater under/over-estimation may be.

The point-based approach, the least square fitting-based approach and the energy-base approach are conventional approaches. These approaches use a derivative of output voltage to input voltage, i.e., Δvₒ/Δvᵢ from the noiseless waveform information. The major weakness with these approaches is the assumption that the output voltage is a function of the input voltage. In reality the output of p-type and n-type transistors and the gates using them are not only dependent on the input voltage level at a certain point, but also the whole input voltage pattern. In other words, the history of the input voltage signal affects the output voltage.

According to Shockley's transistor models, the output current is a function of the input voltage in all transistor working regions, namely cutoff, saturation and linear ones. Because a gate is formed by a combination of p-type and n-type transistors, overall the output current of a gate may be assumed as a function of the input.

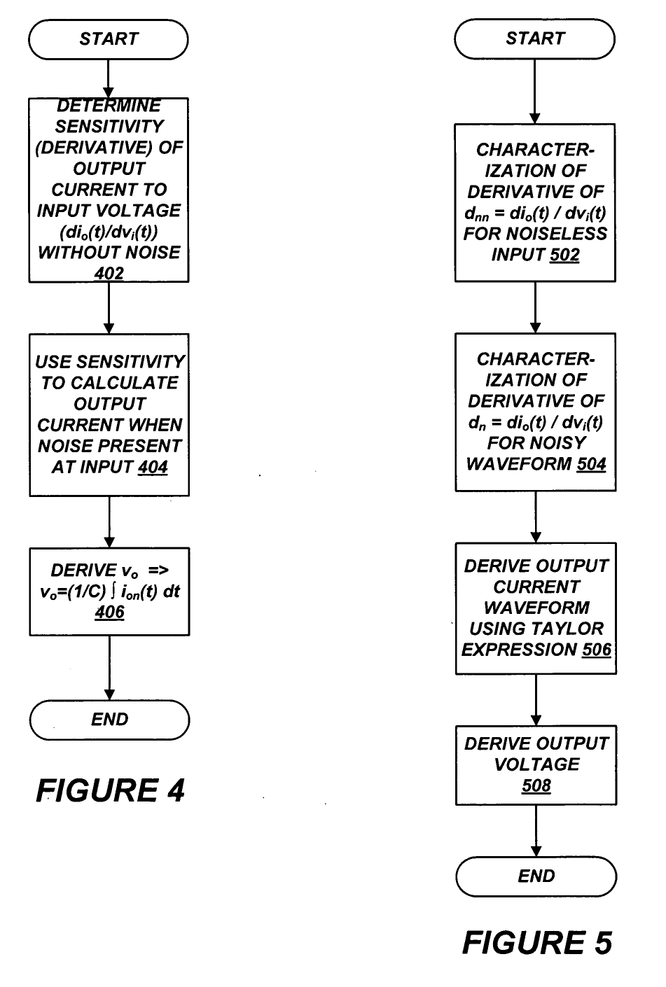

FIG. 4 is a flow chart illustrating a process to determine an output current model using sensitivity analysis according to the present invention. The model generator 110 determines a sensitivity parameter of an output current to an input voltage without noise (block 402). The model generator 110 uses an input voltage and output current relation, (e.g., Δiₒ/Δvᵢ or diₒ(t)/dvᵢ(t)) from the noiseless waveform information and applies a scaled version of this sensitivity parameter to the noisy input waveform to derive an output current waveform (block 404). The model generator 110 derives the output voltage waveform vₒ by integrating the output current waveform i₀(t) into an output load capacitance C (block 406).

FIG. 5 is a flow chart illustrating a process to determine an output current model using a Taylor expansion for the process of FIG. 4. The model generator 110 uses a Taylor expansion of the output current to determine an output current, and calculates an output voltage by integrating the output current. The model generator 110 characterizes a derivative of Δnn=Δiₒ/Δvᵢ {or dnn=diₒ(t)/dvᵢ(t)} for an output current with respect to an input voltage for a noiseless input (block 502).

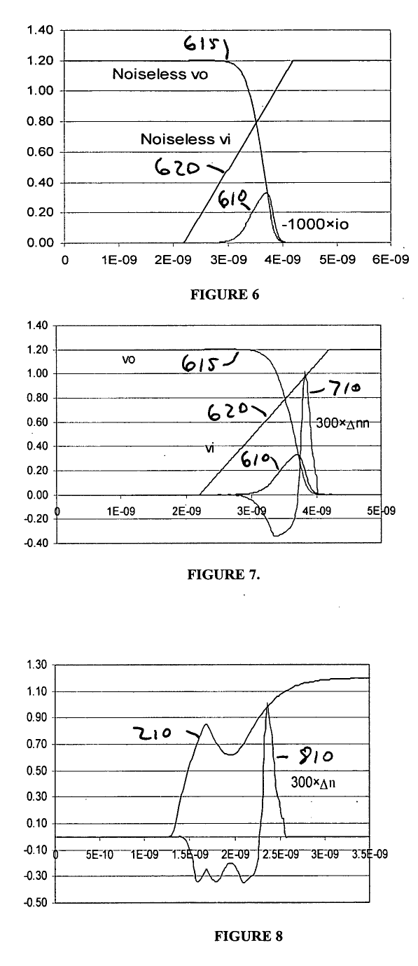

FIG. 6 is a timing diagram illustrating output current for an input current for an inverter. For each gate in the circuit under design, the device library 108 may include a characterization library, for example, an ECSM (Effective Current Source Model). Using this library, the model generator 110 determines an output current waveform (line 610) and an output voltage waveform (line 615) for the output of a gate for a noiseless input voltage waveform (line 620) with a certain slew. FIG. 7 is a timing diagram illustrating a derivative Δₙₙ (line 710) of output current to input voltage for a noiseless waveform of FIG. 6. (For clarity, the waveforms 610 and 710 are exaggerated in FIGS. 6 and 7.) The derivative, Δₙₙ, is defined in the time range [t₁₀, t_{π}], where t₁₀ is the time the input signal passes 10% of the supply voltage Vdd and t₉₀ is the time of 90% of the supply voltage Vdd. The model generator 110 determines the derivative of the output current to the input voltage at each voltage level. The slew for the noiseless input is selected such that it is close to that of the noisy input. The non-linear behavior of the gate makes the slew of the input voltage effective in derivative characterization.

Refer again to FIG. 5. The model generator 110 characterizes a derivative of Δₙ=Δiₒ/Δvᵢ (or dₙ=diₒ(t)/dvᵢ(t)) for a noisy waveform (block 504). After Δₙₙ is determined for each voltage level of the noiseless input, the model generator 110 determines Δₙ, which is the derivative of output current to input voltage for a noisy input:

For all tⱼε[t′₁₀, t′₉₀]: Δₙ[at time step tⱼ]=Δₙₙ [at voltage level V₁] such that vᵢ[tⱼ]=V₁. In other words, at each time step in the range [t′₁₀, t′₉₀] for each voltage level the model generator 110 extracts the corresponding derivative from the noiseless waveform with identical input voltage level. Although a time range is described for the 10% and 90% levels of the supply voltage Vdd, other time ranges may be selected. FIG. 8 is a timing diagram illustrating a derivative Δn (line 810) of output current to input voltage for a noise input as derived from the derivative of the noiseless waveform Δnn of FIG. 7.

The model generator 110 derives the output current waveform using a Taylor expansion (block 506), which for a function f(x) is as follows:

$$f ( x ) - f ( {x}_{0} ) = {f}^{′} ( {x}_{0} ) ( x - {x}_{0} ) + \frac{{f}^{″} ( {x}_{0} )}{2 !} {( x - {x}_{0} )}^{2} + ⋯$$

Considering the output current as a function of input voltage, the Taylor expansion for the output current may be written as:
iₒ^{Equiv}(vᵢ[t])−iₒ^{Equiv}(vᵢ[tⱼ])=Δₙ[tⱼ](vᵢ[t]−vᵢ[tⱼ])+ . . .
where iₒ^{Equiv} is the equivalent output current for the noisy input voltage. Using the first two terms may be sufficient to achieve higher accuracy than the other approaches. In another embodiment, more terms of the Taylor expansion may be used.

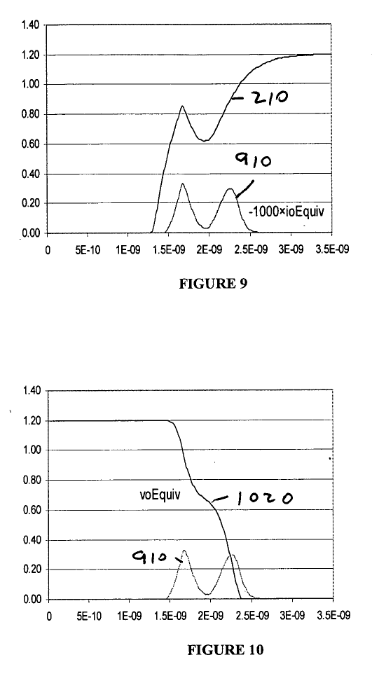

FIG. 9 is a timing diagram illustrating an equivalent output current iₒ^{Equiv} (line 910) for the noisy input voltage of FIG. 8.

The model generator 110 derives the output voltage vₒ^{Equiv} (Block 508) using the output current (block 506). In one embodiment, the model generator 110 determines the output voltage assuming the gate drives a capacitive load, which includes the input gate capacitance of fan out gates as well as the self capacitance of the output interconnect. The model generator 110 may use the following equation to integrate the voltage from the current:

$${i}_{o}^{Equiv} = {c}_{load} \frac{Δ {v}_{o}^{Equiv}}{Δ t}$$

where C_{load} is the effective load capacitance that is known by the STA tool. The model generator 110 uses the above equation to determine the output voltage using a summation of samples for the integration as follows:

$${v}_{o}^{Equiv} [ {t}_{s} ] = \frac{{\sum }_{j = 0}^{S} {i}_{o}^{Equiv} [ {t}_{j} ] Δ {t}_{j}}{{c}_{load}}$$

where S is the number of samples, and t_{S} is the last sampling time. Sampling rates may be, for example, one per 4 ps to one per 30 ps. FIG. 10 is a timing diagram illustrating an equivalent output voltage vₒ^{Equiv} (line 1020) for the noisy input voltage of FIG. 8.

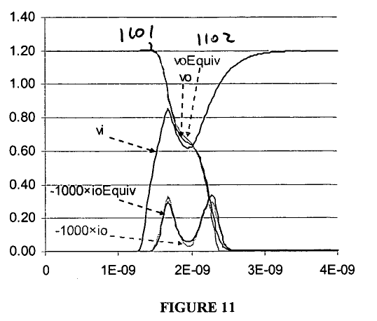

FIG. 11 is a timing diagram illustrating output current and voltage waveforms for a real case and a model determined case according to the present invention. A line 1101 indicates the output voltage for the real case and a line 1102 includes the output voltage determined using the process of FIG. 5.

One benefit of the present invention is that it provides the output waveform which is close to reality, so the results conveys the shape of the waveform at the output, in addition to an equivalent delay and slew for the output as in convention models.

Upon reading this disclosure, those of skill in the art will appreciate still additional alternative structural and functional designs for a system and a process for electronic design automation and generating waveforms for noisy inputs through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method for modeling an electronic element, the method comprising:
determining sensitivity of an output current to an input voltage without noise;
calculating output current in the event noise is present at an input using sensitivity; and
deriving an output voltage from the output current.

2. The method of claim 1,
wherein determining sensitivity further comprises characterizing a derivative of output current over input voltage for a noiseless input;
wherein calculating output current in the event noise is present further comprises characterizing a derivative of output current over input voltage for a noisy waveform;
wherein calculating the output current further comprises deriving an output current waveform using a Taylor expansion; and
wherein deriving an output voltage from the output current further comprises integrating the output current using an equivalent load capacitance.

3. The method of claim 1,
wherein determining sensitivity further comprises characterizing a derivative Δnn=Δiₒ(t)/Δvᵢ(t) of output current iₒ over input voltage vᵢ for a noiseless input;

4. The method of claim 3,
wherein calculating output current in the event noise is present further comprises calculating a derivative Δₙ=Δiₒ/Δvᵢ of output current over input voltage for a noisy waveform at a plurality of times in a time range of the waveform;

5. The method of claim 4,
wherein calculating the output current further comprises deriving an output current waveform iₒ^{Equiv} as:
iₒ^{Equiv}(vᵢ[t])−iₒ^{Equiv}(vᵢ[tⱼ])=Δₙ[tⱼ](vᵢ[t]−vᵢ[tⱼ])
where iₒ^{Equiv} is the equivalent output current for the noisy input voltage; and

6. The method of claim 5,
wherein deriving an output voltage from the output current further comprises determining the output voltage as:
$${v}_{o}^{Equiv} [ {t}_{s} ] = \frac{{\sum }_{j = 0}^{S} {i}_{o}^{Equiv} [ {t}_{j} ] Δ {t}_{j}}{{c}_{load}}$$
where S is the number of samples, and t_{S} is the last sampling time.

7. The method of claim 3 wherein calculating the derivative Δₙ further comprises using a time range corresponding to a switching in voltage of the input waveform between approximately 10% and 90% of a peak of the input waveform.

8. Computer code for causing a computer to execute instructions for modeling an electronic element, the computer code comprising:
computer code for determining sensitivity of an output current to an input voltage without noise;
computer code for calculating output current in the event noise is present at an input using sensitivity; and
computer code for deriving an output voltage from the output current.

9. The computer code of claim 8,
wherein the computer code for determining sensitivity further comprises computer code for characterizing a derivative of output current over input voltage for a noiseless input;
wherein the computer code for calculating output current in the event noise is present further comprises computer code for characterizing a derivative of output current over input voltage for a noisy waveform;
wherein the computer code for calculating the output current further comprises computer code for deriving an output current waveform using a Taylor expansion; and
wherein the computer code for deriving an output voltage from the output current further comprises computer code for integrating the output current using an equivalent load capacitance.

10. The computer code of claim 8,
wherein the computer code for determining sensitivity further comprises computer code for characterizing a derivative Δnn=Δiₒ(t)/Δvᵢ(t) of output current iₒ over input voltage vᵢ for a noiseless input;

11. The computer code of claim 10,
wherein the computer code for calculating output current in the event noise is present further comprises computer code for calculating a derivative Δₙ=Δiₒ/Δvᵢ of output current over input voltage for a noisy waveform at a plurality of times in a time range of the waveform;

12. The computer code of claim 11,
wherein the computer code for calculating the output current further comprises computer code for deriving an output current waveform iₒ^{Equiv} as:
iₒ^{Equiv}(vᵢ[t])−iₒ^{Equiv}(vᵢ[tⱼ])=Δₙ[tⱼ](vᵢ[t]−vᵢ[tⱼ])
where iₒ^{Equiv} is the equivalent output current for the noisy input voltage; and

13. The computer code of claim 12,
wherein the computer code for deriving an output voltage from the output current further comprises computer code for determining the output voltage as:
$${v}_{o}^{Equiv} [ {t}_{s} ] = \frac{{\sum }_{j = 0}^{S} {i}_{o}^{Equiv} [ {t}_{j} ] Δ {t}_{j}}{{c}_{load}}$$
where S is the number of samples, and t_{S} is the last sampling time.

14. The computer code of claim 10 wherein the computer code for calculating the derivative Δₙ further comprises computer code for using a time range corresponding to a switching in voltage of the input waveform between approximately 10% and 90% of a peak of the input waveform.

15. A system for modeling an electronic element comprising:
a first model generator configured to determine sensitivity of an output current to an input voltage without noise;
a second model generator configured to calculate output current in the event noise is present at an input using sensitivity; and
a third model generator configured to derive an output voltage from the output current.

16. The system of claim 15,
wherein the first model generator is configured to characterize a derivative of output current over input voltage for a noiseless input;
wherein the second model generator is configured to characterize a derivative of output current over input voltage for a noisy waveform;
wherein the second model generator is configured to derive an output current waveform using a Taylor expansion; and
wherein the third model generator is configured to integrate the output current using an equivalent load capacitance.

17. The system of claim 15,
wherein the first model generator is configured to characterize a derivative Δnn=Δiₒ(t)/Δvᵢ(t) of output current iₒ over input voltage vᵢ for a noiseless input;

18. The system of claim 17,
wherein the second model generator is configured to calculate a derivative Δₙ=Δiₒ/Δvᵢ of output current over input voltage for a noisy waveform at a plurality of times in a time range of the waveform;

19. The system of claim 18,
wherein the second model generator is configured to derive an output current waveform iₒ^{Equiv} as:
iₒ^{Equiv}(vᵢ[t])−iₒ^{Equiv}(vᵢ[tⱼ])=Δₙ[tⱼ](vᵢ[t]−vᵢ[tⱼ])
where iₒ^{Equiv} is the equivalent output current for the noisy input voltage; and

20. The system of claim 19,
wherein the third model generator is configured to determine the output voltage as:
$${v}_{o}^{Equiv} [ {t}_{s} ] = \frac{{\sum }_{j = 0}^{S} {i}_{o}^{Equiv} [ {t}_{j} ] Δ {t}_{j}}{{c}_{load}}$$
where S is the number of samples, and t_{S} is the last sampling time.

21. The system of claim 17 wherein the second model generator is configured to calculate the derivative Δₙ using a time range corresponding to a switching in voltage of the input waveform between approximately 10% and 90% of a peak of the input waveform.
